(19) United States
(12) Patent Application Publication
(10) Pub. No.: US 2020/0327409 A1
(43) Pub. Date: Oct. 15, 2020

(54) METHOD AND DEVICE FOR HIERARCHICAL LEARNING OF NEURAL NETWORK, BASED ON WEAKLY SUPERVISED LEARNING

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Kyung-su KIM, Seoul (KR); In So KWEON, Daejeon (KR); Dahun KIM, Daejeon (KR); Donghyeon CHO, Daejeon (KR); Sung-Jin KIM, Yongin-si (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 16/758,089

(22) PCT Filed: Nov. 16, 2017
(86) PCT No.: PCT/KR2017/013003

§ 371 Date: Apr. 22, 2020

(51) Int. Cl. G06N 3/08; G06N 3/04

(52) U.S. Cl. CPC G06N 3/08; G06N 3/0454

(57) ABSTRACT

The present disclosure relates to an artificial intelligence (AI) system for simulating functions of the human brain, such as cognition and determination, by using a machine learning algorithm, such as deep learning, and to an application of the AI system. Particularly, the present disclosure relates to a method for hierarchical learning of a neural network according to an AI system and an application thereof, whereby a first activation map may be generated by applying a source learning image to a first learning network model configured to generate semantic segmentation, a second activation map may be generated by applying the source learning image to a second learning network model configured to generate semantic segmentation, a loss may be calculated from labeled data of the source learning image based on the first activation map and the second activation map, and a weight for a plurality of network nodes constituting the first learning network model and the second learning network model may be updated based on the loss.

### TECHNICAL FIELD

The disclosed embodiments relate to a method for hierarchical learning of a neural network based on weakly supervised learning, a device for hierarchical learning of a neural network based on weakly supervised learning, and a recording medium having recorded thereon a program configured to perform the method for hierarchical learning of a neural network based on weakly supervised learning.

### BACKGROUND ART

Artificial intelligence (AI) systems are computer systems for implementing human-level intelligence, and unlike conventional rule-based smart systems, AI systems get smarter while a machine self-learns and self-determines. The more an AI system is used, the more the AI system's recognition rate improves and the more it can accurately understand user preferences, and thus, conventional rule-based smart systems are gradually being replaced with deep learning-based AI systems.

AI technology includes machine learning (deep learning) and element technologies using the machine learning.

Machine learning is an algorithm technology of self-classifying/self- learning features of input data, and element technologies are technologies utilizing a machine learning algorithm such as deep learning and include technical fields such as linguistic understanding, visual understanding, inference/prediction, knowledge representation, and motion control.

Various fields to which AI technology is applied are as follows. The linguistic understanding is a technology of recognizing and applying/processing human languages/characters and includes natural language processing, machine translation, conversation system, query response, voice recognition/synthesis, and the like. The visual understanding is a technology of recognizing and processing a thing like human vision and includes object recognition, object tracking, image search, human recognition, scene understanding, space understanding, image enhancement, and the like. The inference/prediction is a technology of determining information and performing logical inference and prediction and includes knowledge/probability-based inference, optimization prediction, preference-based planning, recommendation, and the like. The knowledge representation is a technology of automatically processing human experience information as knowledge data and includes knowledge construction (data creating/classification), knowledge management (data utilization), and the like. The motion control is a technology of controlling a motion of a robot and includes movement control (navigation, collision, and traveling), operation control (behavior control), and the like.

### DESCRIPTION OF EMBODIMENTS

### TECHNICAL PROBLEM

According to various embodiments, a method and device for hierarchical learning of a neural network based on weakly supervised learning are provided. The technical problems to be solved through the present embodiments are not limited to the technical problems described above, and other technical problems may be inferred from the embodiments below.

### SOLUTION TO PROBLEM

According to an embodiment of the present disclosure, there is provided a method for hierarchical learning of a neural network, the method including: generating a first activation map by applying a source learning image to a first learning network model configured to learn semantic segmentation; generating a second activation map by applying the source learning image to a second learning network model configured to learn semantic segmentation; calculating a loss from labeled data of the source learning image based on the first activation map and the second activation map; and updating, based on the loss, a weight for a plurality of network nodes constituting the first learning network model and the second learning network model.

The second learning network model may be configured to learn a remaining region from the source learning image excluding an image region inferred from the first learning network model.

The updating of the weight for the plurality of network nodes may be performed when the loss is less than a predetermined threshold, and the method may further include applying the source learning image to a third learning network model configured to perform semantic segmentation when the loss is not less than the predetermined threshold.

The labeled data may include an image-level annotation for the source learning image.

The semantic segmentation may correspond to a result obtained by estimating, in pixel units, objects in the source learning image.

The method may further include generating semantic segmentation for the source learning image by combining the first activation map and the second activation map.

The first learning network model and the second learning network model may each include a fully convolutional network (FCN).

According to another embodiment of the present disclosure, there is provided a device for hierarchical learning of a neural network, the device including: a memory storing one or more instructions; and at least one processor configured to execute the one or more instructions stored in the memory, wherein the at least one processor is further configured to generate a first activation map by applying a source learning image to a first learning network model configured to learn semantic segmentation, generate a second activation map by applying the source learning image to a second learning network model configured to learn semantic segmentation, calculate a loss from labeled data of the source learning image based on the first activation map and the second activation map, and update, based on the loss, a weight for a plurality of network nodes constituting the first learning network model and the second learning network model.

The second learning network model may be configured to learn a remaining region from the source learning image excluding an image region inferred from the first learning network model.

The update of the weight for the plurality of network nodes may be performed when the loss is less than a predetermined threshold, and the at least one processor may be further configured to apply the source learning image to a third learning network model configured to perform semantic segmentation when the loss is not less than the predetermined threshold.

The labeled data may include an image-level annotation for the source learning image.

The semantic segmentation may be a result obtained by estimating, in pixel units, objects in the source learning image.

The at least one processor may be further configured to generate semantic segmentation for the source learning image by combining the first activation map and the second activation map.

The first learning network model and the second learning network model may include a fully convolutional network (FCN).

According to another embodiment of the present disclosure, there is provided a computer-readable recording medium having recorded thereon a program configured to execute, in a computer, the method described above.

ADVANTAGEOUS EFFECTS OF DISCLOSURE

In a semantic segmentation learning process using image-level labeled data, not only an accurate position of an object but also a size, a range, and a boundary of the object may be effectively estimated to increase recognition accuracy of semantic segmentation.

### BRIEF DESCRIPTION OF DRAWINGS

FIG. 1 illustrates semantic segmentation.

FIG. 2 illustrates a fully convolutional network (FCN).

FIG. 3 illustrates a labeling scheme used for weakly supervised learning.

FIG. 4 illustrates a method of learning semantic segmentation by using a single learning network model.

FIG. 5 illustrates a method of learning semantic segmentation by using a hierarchical learning network model, according to an embodiment.

FIG. 6 illustrates a combination of activation maps generated in respective layers of a neural network to generate semantic segmentation, according to an embodiment.

FIG. 7 is a flowchart of a method for hierarchical learning of a neural network, according to an embodiment.

FIGS. 8 and 9 are block diagrams of devices for hierarchical learning of a neural network, according to embodiments.

FIG. 10 is a block diagram of a processor according to an embodiment.

FIG. 11 is a block diagram of a data learning unit according to an embodiment.

FIG. 12 is a block diagram of a data recognition unit according to an embodiment.

### MODE OF DISCLOSURE

The terms used in disclosed embodiments are those general terms currently widely used in the art, but the terms may vary according to the intention of those of ordinary skill in the art, precedents, or new technology in the art. Also, specified terms may be arbitrary selected, and in this case, the detailed meaning thereof will be described in a corresponding description of the disclosure. Thus, the terms used in the present disclosure should be defined not by simple names but based on the meaning of the terms and the overall description of the disclosure.

Throughout the specification, when a certain part “includes” a certain component, this indicates that the part may further include another component instead of excluding another component unless there is different disclosure. In addition, terms such as “. . . unit” and “. . . module” refer to units that perform at least one function or operation, and the units may be implemented as hardware or software or as a combination of hardware and software.

Hereinafter, embodiments of the present disclosure will be described in detail with reference to the accompanying drawings so that those of ordinary skill in the art to which the present disclosure belongs may easily realize the present disclosure. However, the present disclosure may be embodied in many different forms and should not be construed as being limited to the embodiments set forth herein.

Hereinafter, embodiments of the present disclosure will be described in detail with reference to the accompanying drawings.

The present disclosure relates to a method and device for hierarchical learning of a neural network based on weakly supervised learning. Particularly, the present disclosure relates to a method and device for hierarchical learning of a neural network for pixel-level image recognition.

A neural network may be designed to simulate a human brain structure in a computer. The neural network may include an artificial intelligence (AI) neural network model or a deep learning network model developed from a neural network model. Examples of various types of deep learning networks may include a fully convolutional network (FCN), a convolutional neural network (CNN), a recurrent neural network (RNN), a deep belief network (DBN), a restricted Boltzman machine (RBM) scheme, and the like but are not limited thereto.

A learning network model using a structure of a neural network includes a plurality of network nodes having a weight, which simulate neurons of the human neural network. In this case, network nodes of the neural network form links to other network nodes. The plurality of network nodes may be designed to simulate a synaptic activity in which neurons give and take a signal through synapses.

The purpose of supervised learning is to find an answer through an algorithm. Therefore, a neural network model based on supervised learning may be a model in a form of inferring a function from training data. In supervised learning, a labeled sample (data having a target output value) is used for training.

A supervised learning algorithm receives a series of training data and a target output value corresponding to the series of training data, finds an error through learning of comparing an actual output value of input data with a target output value, and corrects a model based on a corresponding result. Supervised learning may be divided into regression, classification, detection, semantic segmentation, and the like according to a form of a result. A function derived through the supervised learning algorithm is used again to predict a new result value. As such, the supervised learning-based neural network model optimizes a parameter of the neural network model through learning of many pieces of training data.

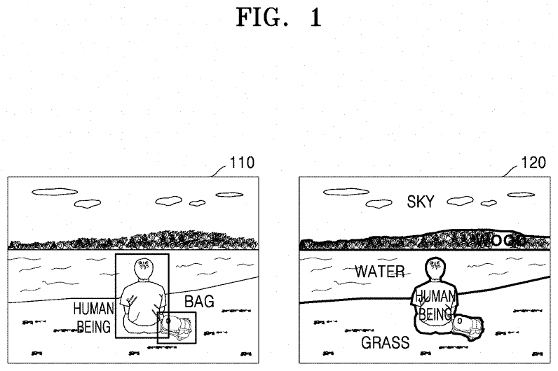

FIG. 1 illustrates semantic segmentation.

Referring to FIG. 1, two results of supervised learning are shown. A result 110 shown in FIG. 1 indicates object detection, and a result 120 indicates semantic segmentation.

Detection indicates a technology of checking whether an image includes a specific object. For example, in the result 110, an object corresponding to ‘human being’ and an object corresponding to ‘bag’ may be shown by quadrangular regions named bounding boxes. In this case, a bounding box may represent even position information of an object. Therefore, detection may include a technology of checking even position information of an object in addition to checking whether there exists an object.

Semantic segmentation indicates a technology of separating an object of a meaningful unit by performing pixel-unit estimation unlike the detection technology of simply checking the presence/absence and position of an object by using a bounding box or the like. That is, semantic segmentation may be a technology of distinguishing, in pixel units, objects constituting an image input to a learning model. For example, in the result 120, objects corresponding to ‘sky’, ‘wood’, ‘water’, ‘human being’, ‘grass’, and the like may be distinguished in pixel units. The result 120 in which objects are distinguished in pixel units may be referred to as a semantic segmentation.

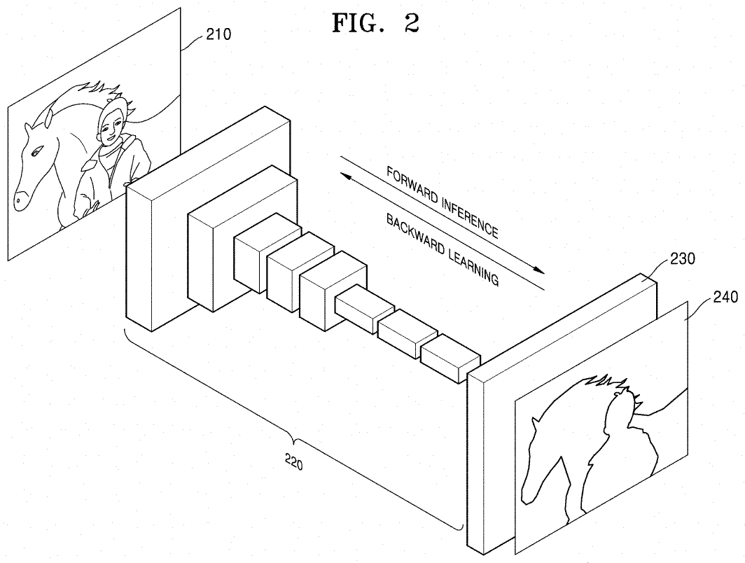

Through semantic segmentation, what exists in an image (i.e., semantic) may be checked, and a position, a size, a range, and a boundary (i.e., segmentation) of an object may also be accurately detected. However, because the element called semantic and the element called segmentation pull in different directions due to the natures thereof, the performance of semantic segmentation may be improved when the two elements are harmoniously solved. Network learning models for generating a semantic segmentation has been continuously proposed. Recently, an FCN in which a structure of some layers in a learning network model for classification is modified exhibits an improved performance. Hereinafter, the FCN will be described with reference to FIG. 2.

FIG. 2 illustrates an FCN.

Referring to FIG. 2, a source learning image 210, an FCN 220, an activation map 230 output from the FCN 220, and labeled data 240 of the source learning image are shown.

General networks for classification include a plurality of hidden layers, and a fully connected layer exists in the last nodes of these networks. However, such a network including the fully connected layer is not suitable for generation of a semantic segmentation. For a first reason, the fully connected layer receives only an input of a fixed size. For a second reason, a result output through the fully connected layer does not include position information of an object any more, but because position information (or spatial information) of an object should be known for an element called segmentation, the second reason becomes a serious problem.

The FCN 220 shown in FIG. 2 may maintain position information of an object by modifying the fully connected layer to a 1×1 convolutional form. Therefore, the FCN 220, which is a network consisting of only convolution layers, may be free from a restriction of an input size, and position information of an object does not disappear, and thus, the FCN 220 may be suitable to generate a semantic segmentation.

The convolution layers in the FCN 220 may be used to extract “features” such as an edge and a line color from complex input data. Each convolution layer may receive data, process data input to a corresponding layer, and generate data to be output from the corresponding layer. Data output from a convolution layer is generated by convoluting an input image with one or more filters or kernels. Initial convolution layers in the FCN 220 may be configured to extract lower-level features such as edges or gradients from an input. Next convolution layers may extract gradually more complex features such as an eye and a nose. Data output from each convolution layer is called an activation map or a feature map. In addition, the FCN 220 may perform other processing computations besides a computation in which a convolution kernel is applied to an activation map. Examples of the other processing computations may include pooling and resampling but are not limited thereto.

When the source learning image 210 passes through layers of several stages in the FCN 220, a size of an activation map decreases. Because semantic segmentation goes with pixel-unit estimation on an object, a process of increasing a result of the activation map of the decreased size to a size of the source learning image 210 again should be performed for the pixel-unit estimation. There are many methods of magnifying a score value obtained through 1×1 convolutional computation to the size of the source learning image 210. For example, there are methods of reinforcing a detail of an activation map of a decreased size through a bilinear interpolation scheme, a deconvolution scheme, a skip layer scheme, and the like, but the methods are not limited thereto. Therefore, a size of the activation map 230 finally output from the FCN 220 may be the same as the size of the source learning image 210. A series of processes in which the FCN 220 receives the source learning image 210 and outputs the activation map 230 is referred to as ‘forward inference’.

Losses may be calculated by comparing the activation map 230 output from the FCN 220 with the labeled data 240 of the source learning image. The losses may be back-propagated to the convolution layers by means of a back propagation scheme. Connection weights in the convolution layers may be updated based on the back-propagated losses. A method of calculating a loss is not limited to a specific scheme, and for example, hinge loss, square loss, softmax loss, cross-entropy loss, absolute loss, insensitive loss, or the like may be used according to purposes.

A method of learning through a back propagation algorithm (i.e., ‘backward learning’) is a method of updating weights of nodes constituting a learning network according to a loss calculated by backwardly transferring a value in a direction from an output layer to an input layer when a comparison result between a value y obtained through the output layer by starting from the input layer and a reference label value is a wrong answer. In this case, a training data set provided to the FCN 220 is called ground truth data or the labeled data 240. A label may indicate a class of a corresponding object.

After the FCN 220 performs a learning process using the source learning image 210, a learning model having an optimized parameter is generated, and when non-labeled data is input to the generated model, a result value (i.e., label) corresponding to the input data may be predicted.

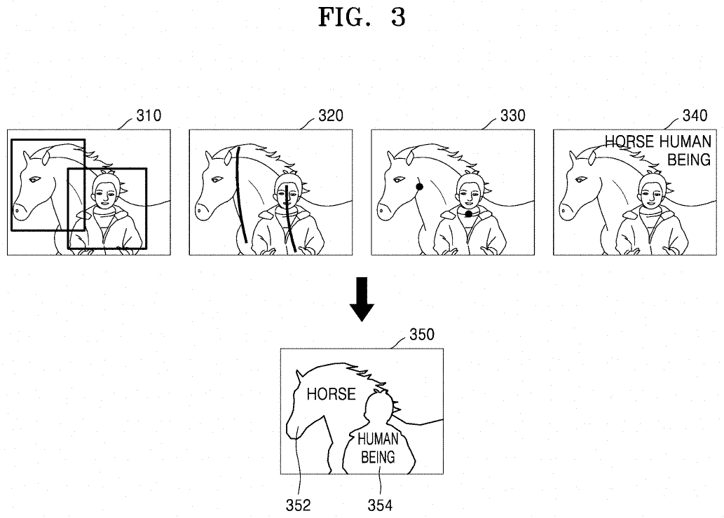

In addition, the label of the training data set provided to the FCN 220 may be manually annotated by a human being. A method for hierarchical learning of a neural network, according to a disclosed embodiment, is based on weakly supervised learning. Therefore, a labeling scheme used for the weakly supervised learning will be described with reference to FIG. 3.

FIG. 3 illustrates a labeling scheme used for weakly supervised learning.

In a method learning semantic segmentation by a fully supervised scheme, an annotation on to which class all pixels in a source learning image correspond is made, and such pixel-level annotated data is used as ground truth data. However, pixel-unit annotating is inefficient and requires a high costs.

Referring to FIG. 3, a labeling scheme 310 using bounding box, a labeling scheme 320 using scribble, a labeling scheme 330 using point, an image-level labeling scheme 340, and the like are shown. The image-level labeling scheme 340 among the various labeling schemes is the simplest and most efficient labeling scheme. Because the image-level labeling scheme 340 requires only which classes exist in a source learning image, the image-level labeling scheme 340 requires a much less cost than a pixel-level labeling scheme. As such, learning semantic segmentation only with class information (i.e., image-level annotation) existing in a source learning image is called semantic segmentation based on weakly supervised learning.

Meanwhile, embodiments for increasing accuracy of semantic segmentation 350 by effectively estimating classes, positions, ranges, boundaries, and the like of objects 352 and 354 by using only image-level annotation without pixel-level annotation are disclosed below.

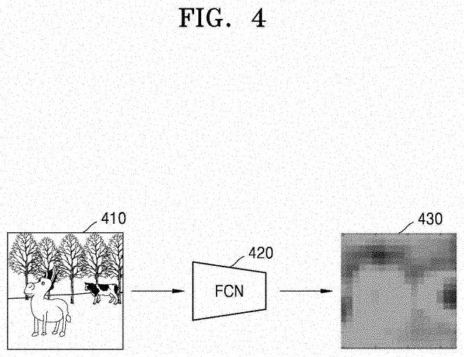

FIG. 4 illustrates a method of learning semantic segmentation by using a single learning network model.

Referring to FIG. 4, a source learning image 410, a single learning network model 420 including an FCN, and an activation map 430 output from the single learning network model are shown.

In a weakly supervised learning process, the single learning network model 420 estimates classes, positions, sizes, ranges, boundaries, and the like of objects existing in the source learning image 410. However, because the single learning network model 420 receives only image-level labeled data in the learning process, the single learning network model 420 is trained to solve a classification problem by concentrating on the most distinctive signal of an object. Therefore, the activation map 430 output from the single learning network model 420 is activated only in the most distinctive regions of objects. The activation map 430 has a good object position estimation performance but cannot accurately estimate a size, a range, and a boundary of an object because the single learning network model 420 concentrates on a local feature of an object (e.g., the ears of a cat, the wheels of a vehicle, or the like) rather than concentrating on a global feature of an object.

Meanwhile, various attempts have been proposed to solve a problem that the performance of estimating a global feature of an object is degraded in learning using the single learning network model 420. For example, there is a scheme of statistically pre-assuming a ratio of the number of pixels in a foreground to the number of pixels in a background for an image and restricting the activation map 430 to expand by the assumed ratio. However, in this case, because high-level semantic of an object existing in an image is not considered, a segmentation output expands regardless of an actual size, range, and boundary of the object.

Therefore, a method for increasing recognition accuracy of semantic segmentation by effectively estimating not only an accurate position of an object but also a size, a range, and a boundary of the object in a semantic segmentation learning process using image-level labeled data is proposed below.

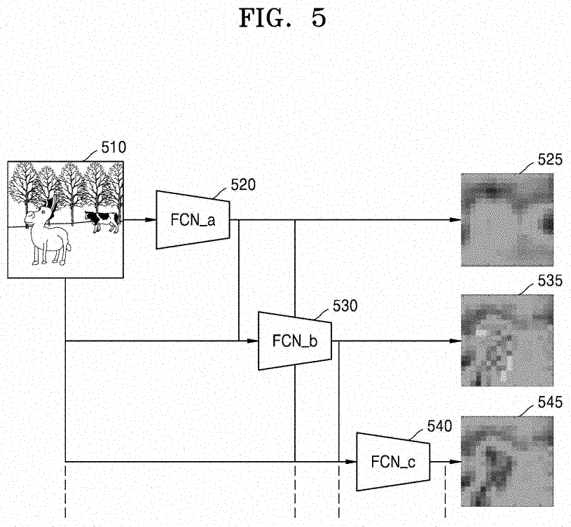

FIG. 5 illustrates a method of learning semantic segmentation by using a hierarchical learning network model, according to an embodiment.

A device for hierarchical learning of a neural network, according to an embodiment, may hierarchically and repeatedly use a plurality of learning network models. The plurality of learning network models according to an embodiment may include an FCN.

Referring to FIG. 5, a source learning image 510, a first learning network model 520 including an FCN, a second learning network model 530 including an FCN, a third learning network model 540 including an FCN, a first activation map 525 output from the first learning network model 520, a second activation map 535 output from the second learning network model 530, and a third activation map 545 output from the third learning network model 540 are shown.

The first learning network model 520, the second learning network model 530, and the third learning network model 540, according to an embodiment, are configured to learn semantic segmentation and commonly use the same image-level labeled data.

Hereinafter, a training operation of the device for hierarchical learning of a neural network, according to an embodiment, will be described.

The device for hierarchical learning of a neural network, according to an embodiment, trains the first learning network model 520 to solve a classification problem by using image-level labeled data. In detail, the device for hierarchical learning of a neural network may calculate a loss loss_a from labeled data of the source learning image 510 based on the first activation map 525 output from the first learning network model 520. The device for hierarchical learning of a neural network, according to an embodiment, may train the first learning network model 520 when the loss loss_a is less than a preset threshold. The device for hierarchical learning of a neural network, according to an embodiment, may proceed to a next operation when the loss_a is not less than the preset threshold.

According to an embodiment, when the loss_a is not less than the preset threshold, the first activation map 525 output from the first learning network model 520 may be input to the second learning network model 530 together with the source learning image 510. The second learning network model 530 according to an embodiment may be trained to solve the classification problem based on the source learning image 510 and the first activation map 525. In this case, the second learning network model 530 may receive information about a position and a region at which the first learning network model 520 has inferred an object. Therefore, the second learning network model 530 may output the second activation map 535 by learning a region remaining by excluding the image region inferred by the first learning network model 520 from the source learning image 510. That is, compared with the first activation map 525, the second activation map 535 may have a different position, size, range, and boundary of an activated region.

The device for hierarchical learning of a neural network, according to an embodiment, may calculate a loss loss_b from the labeled data of the source learning image 510 based on the first activation map 525 and the second activation map 535. The device for hierarchical learning of a neural network, according to an embodiment, may train the first learning network model 520 and the second learning network model 530 when the loss loss_b is less than the preset threshold. The device for hierarchical learning of a neural network, according to an embodiment, may proceed to a next operation when the loss_b is not less than the preset threshold.

As described above, the device for hierarchical learning of a neural network, according to an embodiment, may determine whether a hierarchy expands by comparing a loss calculated at each hierarchy with a threshold. In addition, the device for hierarchical learning of a neural network, according to an embodiment, may output different activation maps for hierarchies by learning a relation between a signal of a previous hierarchy and a signal of a subsequent hierarchy. To this end, the device for hierarchical learning of a neural network, according to an embodiment, may store an output (i.e., activation map) of a learning network model of a previous hierarchy and newly learn a learning network model of a subsequent hierarchy.

In the same manner, the third learning network model 540, according to an embodiment, may receive the source learning image 510, the first activation map 525 output from the first learning network model 520, and the second activation map 535 output from the second learning network model 530. The third learning network model 540, according to an embodiment, may also perform learning by concentrating on a region different from the regions of the object on which the first learning network model 520 and the second learning network model 530 have concentrated.

The device for hierarchical learning of a neural network, according to an embodiment, may expand learning network models to x (x is an integer of 1 or greater) hierarchies and determine whether a hierarchy expands according to a degree of decrease in a loss loss_x in each hierarchy.

Hereinafter, a testing operation of the device for hierarchical learning of a neural network, according to an embodiment, will be described.

When an arbitrary image is input to the device for hierarchical learning of a neural network, according to an embodiment, a plurality of learning network models (e.g., the first learning network model 520, the second learning network model 530, and the third learning network model 540, and the like) may generate activation maps in respective hierarchies. In this case, each activation map generated in each hierarchy may be activated in different region. Thereafter, the device for hierarchical learning of a neural network, according to an embodiment, may generate a final activation map covering the entire region of an object by combining all the activation maps in the respective hierarchies. The device for hierarchical learning of a neural network, according to an embodiment, may generate semantic segmentation based on the generated final activation map.

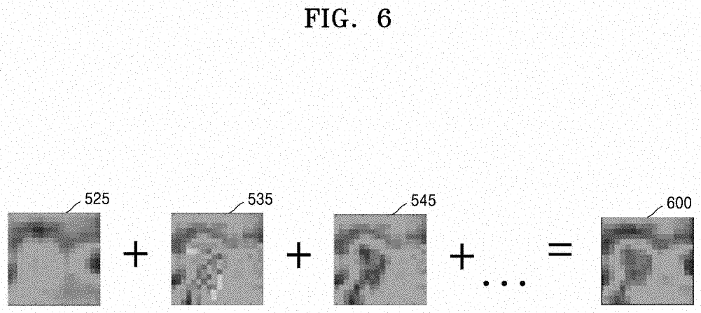

FIG. 6 illustrates a combination of activation maps generated in respective layers of a neural network to generate semantic segmentation, according to an embodiment.

Referring to FIG. 6, the first activation map 525, the second activation map 535, and the third activation map 545 are shown.

The device for hierarchical learning of a neural network, according to an embodiment, may generate a final activation map 600 by combining outputs of learning network models in respective hierarchies. The device for hierarchical learning of a neural network, according to an embodiment, may expand the learning network models to an arbitrary number of hierarchies, and thus, it should be analyzed that the number of activation maps is not limited to the number shown in FIG. 6.

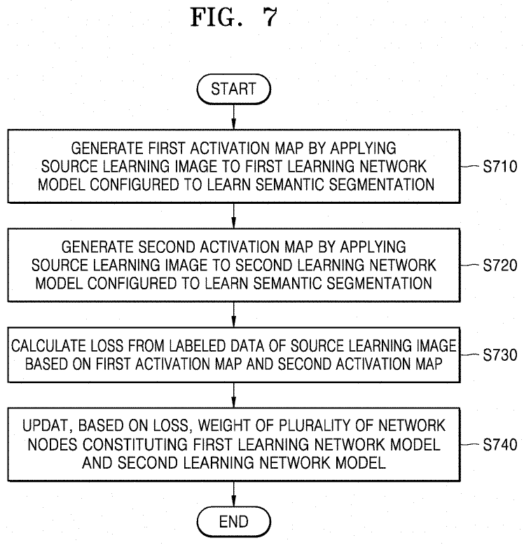

FIG. 7 is a flowchart of a method for hierarchical learning of a neural network, according to an embodiment.

In operation S710, a device for hierarchical learning of a neural network may generate a first activation map by applying a source learning image to a first learning network model configured to learn semantic segmentation.

In operation S720, the device for hierarchical learning of a neural network may generate a second activation map by applying the source learning image to a second learning network model configured to learn semantic segmentation.

In operation S730, the device for hierarchical learning of a neural network may calculate a loss from labeled data of the source learning image based on the first activation map and the second activation map.

In operation S740, the device for hierarchical learning of a neural network may update, based on the calculated loss, a weight of a plurality of network nodes constituting the first learning network model and the second learning network model.

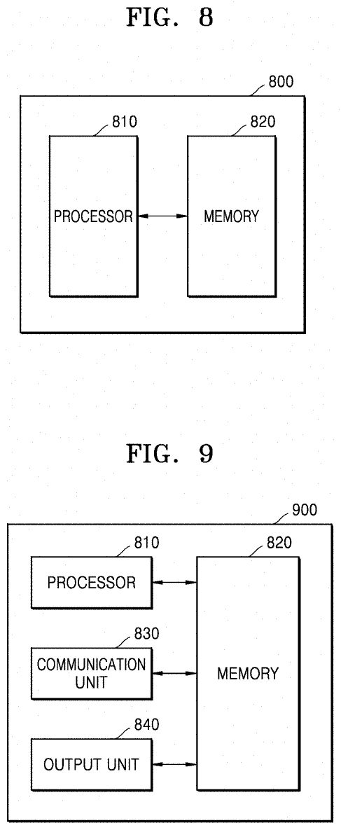

FIGS. 8 and 9 are block diagrams of devices for hierarchical learning of a neural network, according to embodiments.

Referring to FIG. 8, a device 800 for hierarchical learning of a neural network (hereinafter, “learning device”) may include a processor 810 and a memory 820. However, this is only illustrative, and the learning device 800 may include more or fewer components than the processor 810 and the memory 820. For example, referring to FIG. 9, a device 900 according to another embodiment may further include a communication unit 830 and an output unit 840 besides the processor 810 and the memory 820. In addition, according to another example, the learning device 800 may include a plurality of processors.

The processor 810 may include one or more cores (not shown), a graphics processing unit (not shown), and/or a connection passage (e.g., a bus or the like) through which a signal is transmitted and received to and from another component.

According to an embodiment, the processor 810 may perform the operations of the device for hierarchical learning of a neural network, which have been described with reference to FIGS. 5 to 7.

For example, the processor 810 may generate a first activation map by applying a source learning image to a first learning network model configured to learn semantic segmentation. The processor 810 may generate a second activation map by applying the source learning image to a second learning network model configured to learn semantic segmentation. The processor 810 may calculate a loss from labeled data of the source learning image based on the first activation map and the second activation map. The processor 810 may update, based on the calculated loss, a weight of a plurality of network nodes constituting the first learning network model and the second learning network model.

In addition, the processor 810 may apply the source learning image to a third learning network model configured to learn semantic segmentation when the loss is not less than a preset threshold.

In addition, the processor 810 may generate semantic segmentation for the source learning image by combining the first activation map and the second activation map.

The processor 810 may further include random access memory (RAM: not shown) and read-only memory (ROM: not shown) temporarily and/or permanently storing a signal (or data) processed in the inside thereof. In addition, the processor 810 may be implemented in a form of system on chip (SoC) including at least one of the graphics processing unit, the RAM, or the ROM.

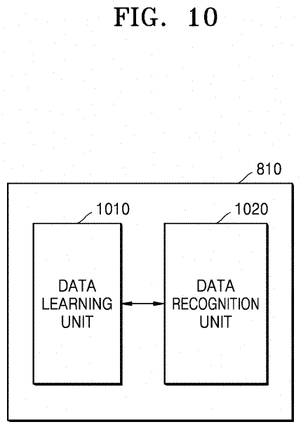

The memory 820 may store programs (one or more instructions) for processing and control of the processor 810. The programs stored in the memory 820 may be classified into a plurality of modules according to functions thereof. According to an embodiment, the memory 820 may include a data learning unit and a data recognition unit to be described below with reference to FIG. 10. In addition, the data learning unit and the data recognition unit may independently include learning network models, respectively, or share a single learning network model.

The communication unit 830 may include one or more components for communicating with an external server and other external devices. The communication unit 830 may receive, from a server, activation maps acquired using learning network models stored in the server. alternatively, the communication unit 830 may transmit, to the server, activation maps generated using the learning network models.

The output unit 840 may output the generated activation maps and semantic segmentation.

The learning device 800 may include, for example, a PC, a laptop computer, a cellular phone, a micro-server, a global positioning system (GPS) device, a smartphone, a wearable terminal, an e-book terminal, a home appliance, an electronic device in a vehicle, and another mobile or non-mobile computing device. However, the learning device 800 is not limited thereto and may include all types of device having a data processing function.

FIG. 10 is a block diagram of the processor 810 according to an embodiment.

Referring to FIG. 10, the processor 810 according to an embodiment may include a data learning unit 1010 and a data recognition unit 1020.

The data learning unit 1010 may learn a reference to generate an activation map or semantic segmentation from a source learning image. According to the learned reference, a weight of at least one layer included in the data learning unit 1010 may be determined.

The data recognition unit 1020 may extract an activation map or semantic segmentation or recognize a class of an object included in an image, based on the reference learned through the data learning unit 1010.

At least one of the data learning unit 1010 and the data recognition unit 1020 may be manufactured in a form of at least one hardware chip and equipped in a neural network learning device. For example, at least one of the data learning unit 1010 and the data recognition unit 1020 may be manufactured in a form of exclusive hardware chip for an AI, or manufactured as a part of an existing general-use processor (e.g., a central processing unit (CPU) or an application processor) or a graphic exclusive processor (e.g., a graphic processing unit (GPU)) and may be equipped in various types of neural network learning devices described above.

In this case, the data learning unit 1010 and the data recognition unit 1020 may be equipped in one neural network learning device or respectively equipped in individual neural network learning devices. For example, one of the data learning unit 1010 and the data recognition unit 1020 may be included in a device, and the other one may be included in a server. In addition, in a wired or wireless manner between the data learning unit 1010 and the data recognition unit 1020, model information constructed by the data learning unit 1010 may be provided to the data recognition unit 1020, and data input to the data recognition unit 1020 may be provided as additional training data to the data learning unit 1010.

Alternatively, at least one of the data learning unit 1010 and the data recognition unit 1020 may be implemented as a software module. When at least one of the data learning unit 1010 and the data recognition unit 1020 is implemented as a software module (or a program module including instructions), the software module may be stored in a non-transitory computer-readable recording medium. In addition, in this case, at least one software module may be provided by an operating system (OS) or a certain application. Alternatively, a part of the at least one software module may be provided by the OS, and the other part may be provided by the certain application.

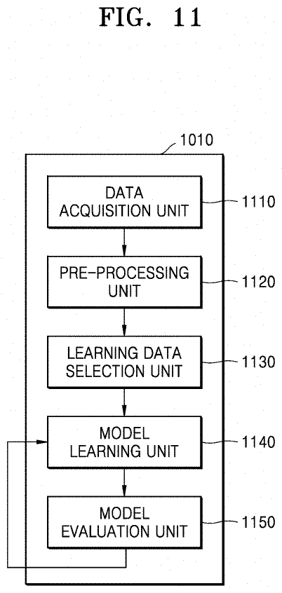

FIG. 11 is a block diagram of the data learning unit 1010 according to an embodiment.

Referring to FIG. 11, the data learning unit 1010 according to some embodiments may include a data acquisition unit 1110, a pre-processing unit 1120, a training data selection unit 1130, a model learning unit 1140, and a model evaluation unit 1150. However, this is only illustrative, and the data learning unit 1010 may include fewer components than the components described above, or another component besides the components described above may be additionally included in the data learning unit 1010.

The data acquisition unit 1110 may acquire a source learning image. For example, the data acquisition unit 1110 may acquire at least one image from a neural network learning device including the data learning unit 1010 or an external device or server communicable with the neural network learning device including the data learning unit 1010.

In addition, the data acquisition unit 1110 may acquire activation maps by using the learning network models described above with reference to FIGS. 5 to 7.

The at least one image acquired by the data acquisition unit 1110, according to an embodiment, may be one of images classified according to class. For example, the data acquisition unit 1110 may perform learning based on images classified for types.

The pre-processing unit 1120 may pre-process the acquired image such that the acquired image is used for learning to extract characteristic information of the image or recognize a class of an object in the image. The pre-processing unit 1120 may process the acquired at least one image in a preset format such that the model learning unit 1140 to be described below uses the acquired at least one image for learning.

The training data selection unit 1130 may select an image required for learning from among the pre-processed data. The selected image may be provided to the model learning unit 1140. The training data selection unit 1130 may select an image required for learning from among the pre-processed images according to a set reference.

The model learning unit 1140 may learn a reference regarding what information is used to acquire characteristic information or recognize an object in an image from the image in a plurality of layers of a learning network model. For example, the model learning unit 1140 may learn a reference regarding what characteristic information is to be extracted from a source learning image or what reference is applied to generate semantic segmentation from the extracted characteristic information, to generate semantic segmentation close to labeled data.

According to various embodiments, when there exist a plurality of pre-constructed data recognition models, the model learning unit 1140 may determine, as a data recognition model to be learned, a data recognition model having a high relation of basic training data with input training data. In this case, the basic training data may be pre-classified for each data type, and the data recognition models may be pre-constructed for each data type. For example, the basic training data may be pre-classified based on various references such as a generation region of training data, a generation time of the training data, a size of the training data, a genre of the training data, a generator of the training data, and a type of an object in the training data.

In addition, the model learning unit 1140 may learn a data generation model through, for example, reinforcement learning using a feedback on whether a class recognized according to learning is right.

In addition, when the data generation model is learned, the model learning unit 1140 may store the learned data generation model. In this case, the model learning unit 1140 may store the learned data generation model in a memory of a neural network learning device including the data acquisition unit 1110. Alternatively, the model learning unit 1140 may store the learned data generation model in a memory of a server connected to the neural network learning device via a wired or wireless network.

In this case, the memory in which the learned data generation model is stored may also store, for example, a command or data related to at least one other component of the neural network learning device. In addition, the memory may store software and/or programs. The programs may include, for example, a kernel, middleware, an application programming interface (API) and/or application programs (or “applications”).

The model evaluation unit 1150 may input evaluation data to the data generation model, and when a generation result of additional training data output based on the evaluation data does not satisfy a predetermined reference, the model evaluation unit 1150 may allow the model learning unit 1140 to perform learning again. In this case, the evaluation data may be preset data for evaluating the data generation model. Herein, the evaluation data may include a difference between labeled data and an activation map generated based on a learning network model, and the like.

When there exist a plurality of learning network models, the model evaluation unit 1150 may evaluate whether each learning network model satisfies the predetermined reference and determine a model satisfying the predetermined reference as a final learning network model.

At least one of the data acquisition unit 1110, the pre-processing unit 1120, the training data selection unit 1130, the model learning unit 1140, and the model evaluation unit 1150 in the data learning unit 1010 may be manufactured in a form of at least one hardware chip and equipped in a neural network learning device. For example, at least one of the data acquisition unit 1110, the pre-processing unit 1120, the training data selection unit 1130, the model learning unit 1140, and the model evaluation unit 1150 may be manufactured in a form of exclusive hardware chip for an AI, or manufactured as a part of an existing general-use processor (e.g., a CPU or an application processor) or a graphic exclusive processor (e.g., a GPU) and may be equipped in various types of neural network learning devices described above.

In addition, the data acquisition unit 1110, the pre-processing unit 1120, the training data selection unit 1130, the model learning unit 1140, and the model evaluation unit 1150 may be equipped in one neural network learning device or respectively equipped in individual neural network learning devices. For example, some of the data acquisition unit 1110, the pre-processing unit 1120, the training data selection unit 1130, the model learning unit 1140, and the model evaluation unit 1150 may be included in a neural network learning device, and the other some may be included in a server.

Alternatively, at least one of the data acquisition unit 1110, the pre-processing unit 1120, the training data selection unit 1130, the model learning unit 1140, and the model evaluation unit 1150 may be implemented as a software module. When at least one of the data acquisition unit 1110, the pre-processing unit 1120, the training data selection unit 1130, the model learning unit 1140, and the model evaluation unit 1150 is implemented as a software module (or a program module including instructions), the software module may be stored in a non-transitory computer-readable recording medium. In addition, in this case, at least one software module may be provided by an OS or a certain application. Alternatively, a part of the at least one software module may be provided by the OS, and the other part may be provided by the certain application.

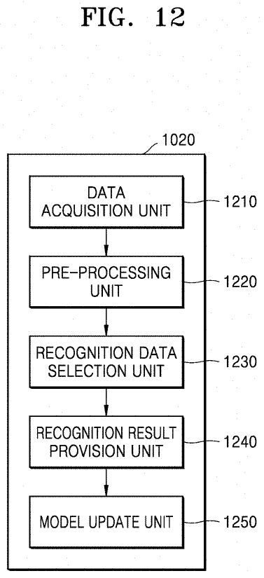

FIG. 12 is a block diagram of the data recognition unit 1020 according to an embodiment.

Referring to FIG. 12, the data recognition unit 1020 according to some embodiments may include a data acquisition unit 1210, a pre-processing unit 1220, a recognition data selection unit 1230, a recognition result provision unit 1240, and a model update unit 1250.

The data acquisition unit 1210 may acquire at least one image required to extract characteristic information of an image or recognize an object in the image, and the pre-processing unit 1220 may pre-process the acquired image such that the acquired at least one image is used to extract characteristic information of an image or recognize a class of an object in the image. The pre-processing unit 1220 may process the acquired image in a preset format such that the recognition result provision unit 1240 to be described below uses the acquired image to extract characteristic information of an image or recognize a class of an object in the image. The recognition data selection unit 1230 may select, from among the pre-processed image, an image required for characteristic extraction or class recognition. The selected data may be provided to the recognition result provision unit 1240.

The recognition result provision unit 1240 may extract characteristic information of an image or recognize an object in the image by applying the selected image to a learning network model according to an embodiment. A method of recognizing an object by inputting at least one image to a learning network model may correspond to the method described above with reference to FIGS. 5 to 7.

The recognition result provision unit 1240 may provide a result of recognizing a class of an object included in at least one image.

The model update unit 1250 may provide information about evaluation to the model learning unit 1140 described above with reference to FIG. 11 such that a parameter or the like of a type classification network or at least one characteristic extraction layer included in a learning network model, based on an evaluation on the result of recognizing a class of an object included in an image, which is provided by the recognition result provision unit 1240.

At least one of the data acquisition unit 1210, the pre-processing unit 1220, the recognition data selection unit 1230, the recognition result provision unit 1240, and the model update unit 1250 in the data recognition unit 1020 may be manufactured in a form of at least one hardware chip and equipped in a neural network learning device. For example, at least one of the data acquisition unit 1210, the pre-processing unit 1220, the recognition data selection unit 1230, the recognition result provision unit 1240, and the model update unit 1250 may be manufactured in a form of exclusive hardware chip for an AI, or manufactured as a part of an existing general-use processor (e.g., a CPU or an application processor) or a graphic exclusive processor (e.g., a GPU) and may be equipped in various types of neural network learning devices described above.

In addition, the data acquisition unit 1210, the pre-processing unit 1220, the recognition data selection unit 1230, the recognition result provision unit 1240, and the model update unit 1250 may be equipped in one neural network learning device or respectively equipped in individual neural network learning devices. For example, some of the data acquisition unit 1210, the pre-processing unit 1220, the recognition data selection unit 1230, the recognition result provision unit 1240, and the model update unit 1250 may be included in a neural network learning device, and the other some may be included in a server.

Alternatively, at least one of the data acquisition unit 1210, the pre-processing unit 1220, the recognition data selection unit 1230, the recognition result provision unit 1240, and the model update unit 1250 may be implemented as a software module. When at least one of the data acquisition unit 1210, the pre-processing unit 1220, the recognition data selection unit 1230, the recognition result provision unit 1240, and the model update unit 1250 is implemented as a software module (or a program module including instructions), the software module may be stored in a non-transitory computer-readable recording medium. In addition, in this case, at least one software module may be provided by an OS or a certain application. Alternatively, a part of the at least one software module may be provided by the OS, and the other part may be provided by the certain application.

A device according to the embodiments may include a processor, a memory for storing and executing program data, a permanent storage such as a disk drive, a communication port for performing communication with an external device, and a user interface, such as a touch panel, a key, and a button. Methods implemented with a software module or an algorithm may be stored in a computer-readable recording medium in the form of computer-readable codes or program instructions executable in the processor. Examples of the computer-readable recording medium include magnetic storage media (e.g., read-only memory (ROM), random-access memory (RAM), floppy disks, hard disks, etc.) and optical recording media (e.g., CD-ROMs, Digital Versatile Discs (DVDs), etc.). The computer-readable recording medium can also be distributed over network coupled computer systems so that the computer-readable code is stored and executed in a distributed fashion. The media can be read by a computer, stored in the memory, and executed by the processor.

The present embodiments can be represented with functional blocks and various processing steps. These functional blocks can be implemented by various numbers of hardware and/or software configurations for executing specific functions. For example, the embodiments may adopt direct circuit configurations, such as memory, processing, logic, and look-up table, for executing various functions under control of one or more microprocessors or by other control devices. Like components being able to execute the various functions with software programming or software elements, the present embodiments can be implemented by a programming or scripting language, such as C, C++, Java, or assembler, with various algorithms implemented by a combination of a data structure, processes, routines, and/or other programming components. Functional aspects can be implemented with algorithms executed in one or more processors. In addition, the present embodiments may adopt the prior art for electronic environment setup, signal processing and/or data processing. The terms, such as “mechanism”, “element”, “means”, and “configuration”, can be widely used and are not delimited as mechanical and physical configurations. The terms may include the meaning of a series of routines of software in association with a processor or the like.

1. A method for hierarchical learning of a neural network, the method comprising:
generating a first activation map by applying a source learning image to a first learning network model configured to learn semantic segmentation;
generating a second activation map by applying the source learning image to a second learning network model configured to learn semantic segmentation;
calculating a loss from labeled data of the source learning image based on the first activation map and the second activation map; and
updating, based on the loss, a weight for a plurality of network nodes constituting the first learning network model and the second learning network model.

2. The method of claim 1, wherein the second learning network model is configured to learn a remaining region from the source learning image excluding an image region inferred from the first learning network model.

3. The method of claim 1, wherein the updating of the weight for the plurality of network nodes is performed when the loss is less than a predetermined threshold, and
the method further comprises applying the source learning image to a third learning network model configured to perform semantic segmentation when the loss is not less than the predetermined threshold.

4. The method of claim 1, wherein the labeled data comprises an image-level annotation for the source learning image.

5. The method of claim 1, wherein the semantic segmentation corresponds to a result obtained by estimating, in pixel units, objects in the source learning image.

6. The method of claim 1, further comprising generating semantic segmentation for the source learning image by combining the first activation map and the second activation map.

7. The method of claim 1, wherein the first learning network model and the second learning network model each comprise a fully convolutional network (FCN).

8. A device for hierarchical learning of a neural network, the device comprising:
a memory storing one or more instructions; and
at least one processor configured to execute the one or more instructions stored in the memory to
generate a first activation map by applying a source learning image to a first learning network model configured to learn semantic segmentation,
generate a second activation map by applying the source learning image to a second learning network model configured to learn semantic segmentation,
calculate a loss from labeled data of the source learning image based on the first activation map and the second activation map, and
update, based on the loss, a weight for a plurality of network nodes constituting the first learning network model and the second learning network model.

9. The device of claim 8, wherein the second learning network model is configured to learn a remaining region from the source learning image excluding an image region inferred from the first learning network model.

10. The device of claim 8, wherein the update of the weight for the plurality of network nodes is performed when the loss is less than a predetermined threshold, and
the at least one processor is further configured to apply the source learning image to a third learning network model configured to perform semantic segmentation when the loss is not less than the predetermined threshold.

11. The device of claim 8, wherein the labeled data comprises an image-level annotation for the source learning image.

12. The device of claim 8, wherein the semantic segmentation corresponds to a result obtained by estimating, in pixel units, objects in the source learning image.

13. The device of claim 8, wherein the at least one processor is further configured to generate semantic segmentation for the source learning image by combining the first activation map and the second activation map.

14. The device of claim 8, wherein the first learning network model and the second learning network model each comprise a fully convolutional network (FCN).

15. A computer-readable recording medium having recorded thereon a program configured to execute, in a computer, the method of claim 1.
